(19) United States
(12) Patent Application Publication
(10) Pub. No.: US 2010/0067970 A1
(43) Pub. Date: Mar. 18, 2010

(54) DISPENSER RECEPTACLE

(76) Inventor: Joong Hyun Ki, Incheon (KR)

Correspondence Address: IPLA P.A., 3550 WILSHIRE BLVD., 17TH FLOOR, LOS ANGELES, CA, 90010, US

(21) Appl. No.: 12/516,555

(22) PCT Filed: Aug. 8, 2008
(86) PCT No.: PCT/KR08/04625

§ 371 Date: May 27, 2009

(30) Foreign Application Priority Data
Aug. 27, 2007 (KR) 20-2007-0014176

(51) Int. Cl. B43K 5/02; B67D 7/84

(52) U.S. Cl. 401/143; 222/162

(57) ABSTRACT

Provided is a dispenser receptacle which include: an external container having an internal accommodation space whose upper portion is opened; an internal container which is inserted into the inside of the external container so as to move longitudinally, and in the inside of which contents are accommodated; a button which is combined so as to move longitudinally along the side wall portion of the external container; a connection unit which connects the button and the internal container and both sides of which move in integral form; and a pumping unit which is combined with an exit portion of the internal container and pumps contents according to ascending and descending of the internal container to then discharge the pumped contents externally, to accordingly minimize a height of the button which is protruded to the outside even though an operational stroke of the button becomes large to thus provide effects of enhancing conveniences in use of users and improving a quality of the external appearance of a product and conveniences at a display of the product, and to further have a simple pumping structure that an internal container ascends and descends in the inside of an external container, and an airless piston moves according to a discharge of contents, and provide for an effect of enhancing an operational reliability and durability of a product.

### TECHNICAL FIELD

The present invention relates to a dispenser receptacle or vessel, and more particularly, to a dispenser receptacle which has a structure that a pumping operation is accomplished by making a button which is provided at one side of a receptacle main body up and down, to thereby discharge contents more conveniently as well as by minimizing a height of the button protruded from the surface of the receptacle main body, to thereby heighten a quality of the external appearance of a product and reduce a space required for storing and displaying the product.

### BACKGROUND ART

In general, a dispenser receptacle is of a structure that contents are externally discharged when a pump button provided in the dispenser receptacle is operated. Accordingly, the dispenser receptacles are widely used as containers for packaging liquid-phase products including cosmetics, medicines, cleaning materials such as detergents, etc., respectively.

By the way, the conventional dispenser receptacles are of a structure that a pusher provided at a cap portion which is located at the upper portion of the conventional dispenser receptacle is pressed to perform a pumping operation, to accordingly cause a user to feel inconveniences that he or she presses a pusher which is located at a position relatively far away from his or her hand, at a state where he or she has taken a hold of the receptacle main body of the conventional dispenser receptacle.

In order to solve this problem, another conventional dispenser receptacle has been provided in which a push button is provided at one side wall of the receptacle main body which is held by a user, and the push button is pressed to perform a pumping operation.

However, such a conventional lateral button type dispenser receptacle has an operational structure that the push button is pressed inwards radially from the receptacle main body. Thus, in the case of lessening a stroke of the push button, the pumping operation is inefficiently achieved, and an amount of contents which are pumped by each operation of the push button becomes small, to resultantly cause inconveniences in use of users. Accordingly, in the case of the conventional dispenser receptacle, the push button should be protruded at a considerable height on the lateral side of the receptacle main body, in order to secure an operational stroke for pumping a proper amount of contents. As a result, a quality of the external appearance of a product is lowered and a more space is required for storing and displaying the product.

### DISCLOSURE OF INVENTION

### Technical Problem

To solve the above problems, it is an object of the present invention to provide a dispenser receptacle which performs a pumping operation of contents contained in the dispenser receptacle by a button which moves longitudinally along the side wall portion of a receptacle main body of the dispenser receptacle, to thus secure a sufficient operational stroke for pumping a proper amount of contents and minimize a height of the button protruded from the receptacle main body.

### Technical Solution

To accomplish the above object of the present invention, according to an aspect of the present invention, there is provided a dispenser receptacle comprising:

an external container having an internal accommodation space whose upper portion is opened;

an internal container which is inserted into the inside of the external container so as to move longitudinally, and in the inside of which contents are accommodated;

a button which is combined so as to move longitudinally along the side wall portion of the external container;

a connection unit which connects the button and the internal container so that both sides of which move in integral form; and

a pumping unit which is combined with an exit portion of the internal container and pumps contents according to ascending and descending of the internal container to then discharge the pumped contents externally.

Preferably but not necessarily, the connection unit comprises a movable sleeve which is combined with the circumferential portion of the internal container, so as to move along the inner wall surface of the external container, in which the button is combined on the outer circumferential surface of the movable sleeve.

More preferably but not necessarily, an airless piston which moves up according to discharge of contents is provided at the lower-inner part of the internal container, and an inner cap having an exit is combined with the upper portion of the internal container, and

the pumping portion comprises:

a support tubular body having a communication path which is fixed to the inner cap and communicates with the exit;

a cover which is combined with the upper portion of the internal container and which is installed to receive an elastic force to the lower side of the support tubular body by a spring;

a pressing body which is combined with the inner side of the cover and has a pressure chamber which communicates with the inside of the internal container through an inlet;

a valve stem which is inserted into and combined with the support tubular body, in which a communication path which connects the pressure chamber of the pressing body and the communication path of the support tubular body is formed and a valve body is provided at the lower portion of the valve stem; and

a valve seat which is fixed in the inside of the pressing body so as to be closely attached to or detached from the valve body.

### Advantageous Effects

As described above, the present invention provides a dispenser receptacle or vessel which has a structure that a button is provided at a position near user's fingers when a user holds the dispenser receptacle, as well as an operational structure of performing a pumping by making the button move longitudinally. Accordingly, the present invention can minimize a height of the button which is protruded to the outside even though an operational stroke of the button becomes large to thus provide effects of enhancing conveniences in use of users and improving a quality of the external appearance of a product and conveniences at a display of the product.

Further, the present invention has a simple pumping structure that an internal container ascends and descends in the inside of an external container, and an airless piston moves according to a discharge of contents. Accordingly, even if contents contained in the dispenser receptacle is reduced, the external form of the product is kept as it is, and there are little contents that remain in the inside of the dispenser receptacle after use. Still further, the present invention provides an effect of enhancing an operational reliability and durability of a product.

### BRIEF DESCRIPTION OF THE DRAWINGS

The above and/or other objects and/or advantages of the present invention will become more apparent by describing the preferred embodiments thereof in detail with reference to the accompanying drawings in which:

FIG. 1 is a partially cutoff perspective view illustrating a dispenser receptacle according to an embodiment of the present invention;

FIG. 2 is a disassembled perspective view of the dispenser receptacle shown in FIG. 1; and

FIGS. 3 and 4 are cross-sectional views showing an opened state and a closed state of the internal structure of the dispenser receptacle of FIG. 1, respectively.

### BEST MODE FOR CARRYING OUT THE INVENTION

Hereinbelow, a dispenser receptacle according to a preferred embodiment of the present invention will be described with reference to the accompanying drawings. Like reference numerals denote like elements through the following embodiments.

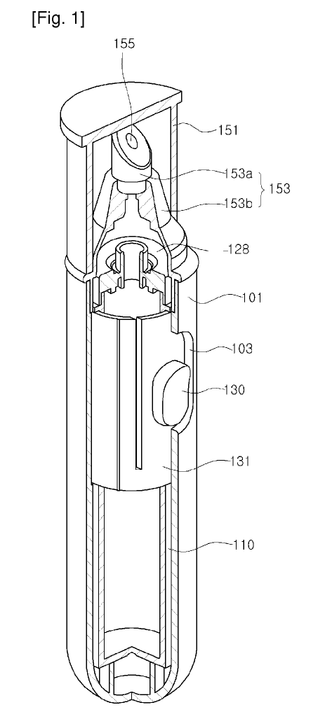

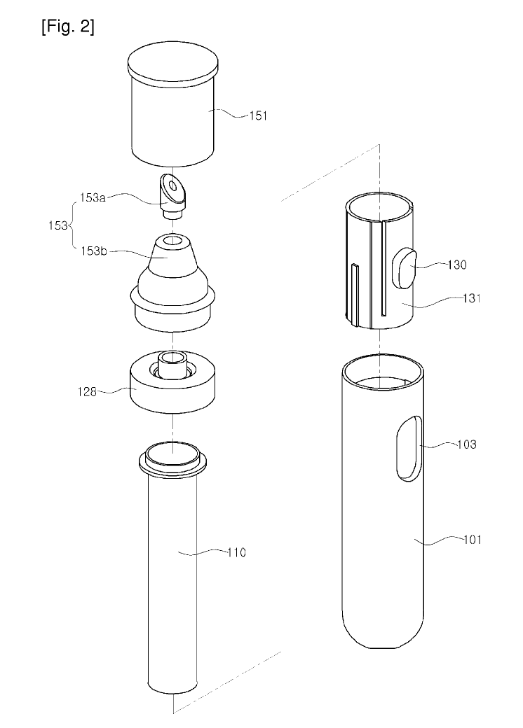

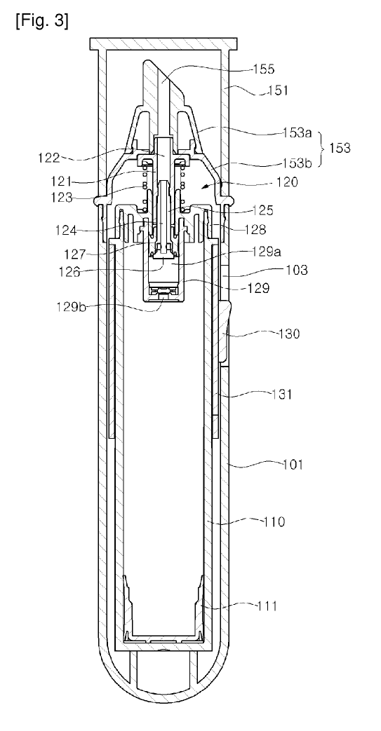

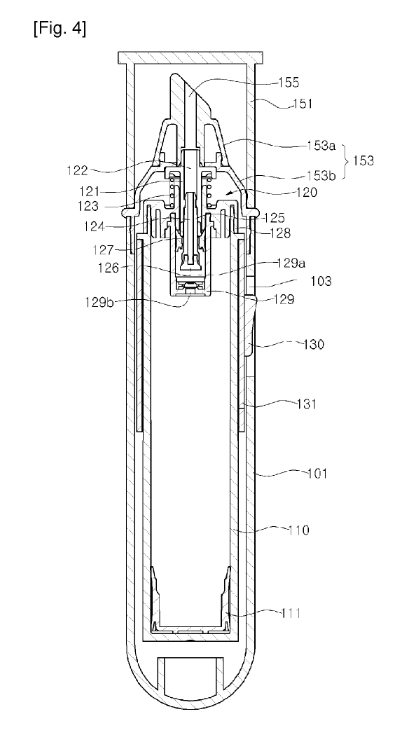

FIGS. 1 and 2 are a partially cutoff perspective view and a disassembled perspective view illustrating a dispenser receptacle according to an embodiment of the present invention, respectively, and FIGS. 3 and 4 are cross-sectional views showing an opened state and a closed state of the internal structure of the dispenser receptacle of FIG. 1, respectively.

As illustrated in FIGS. 1 to 4, a dispenser receptacle according to an embodiment of the present invention includes: an external container 101 which is of a cylinder having an internal accommodation space whose upper portion is opened, and at one side of a side wall portion of which a guide hole 103 is formed; an internal container 110 which is inserted into the inside of the external container 101 so as to move longitudinally, that is, so as to ascend and descend, and in the inside of which contents are accommodated; a button 130 which is combined with the internal container 110 so as to move longitudinally along the guide hole 103 formed at the side wall portion of the external container 101, to thus make the internal container 110 ascend and descend; a pumping unit 120 which is provided at the upper portion of the internal container 110; an inner cap 153 which is combined with the upper portion of the pumping unit 120 in which an exit 155 through which contents are discharged is formed; and an outer cap 151 which is attachably and detachably combined with the upper portion of the inner cap 153.

An airless piston 111 which moves up according to discharge of contents is provided at the lower-inner part of the internal container 110. A movable sleeve 131 is combined with the outer circumferential portion of the internal container 110, as a connection unit which makes the internal container 110 move in combination with movement of the button 130. That is, the upper end of the movable sleeve 131 contacts the upper projection of the internal container 110 so that the sleeve 131 ascends the internal container 110.

Meanwhile, the connection unit which connects the button 130 and the internal container 110 is not limited to the above-described embodiment of the present invention. As an example, the connection unit may be constructed in various forms, which includes a structure of a protrusion and a groove, or locking hooks which combine or connect the button 130 and the internal container 110 with each other, and a conventional structure which connects both sides of the button 130 and the internal container 110 with each other so as to make the button 130 and the internal container 110 move together.

As shown, the inner cap 153 may be divided into an upper body 153 and a lower body 154 for convenience of manufacture, or may be formed of an integral structure.

The pumping portion 120 includes: a support tubular body 121 having a communication path 122 which is fixed to the inner cap 153 and communicates with the exit 155; a cover 128 which is combined with the upper portion of the internal container 110 and which is installed to receive an elastic force to the lower side of the support tubular body 121 by a spring 123; a pressing body 129 which is combined with the inner side of the cover 128 and has a pressure chamber 129a therein; a valve stem 124 which is inserted into and combined with the support tubular body 121, in which a communication path 125 which connects the pressure chamber 129a of the pressing body 129 and the communication path 122 of the support tubular body 121 is longitudinally formed and a valve body 126 is provided at the lower portion of the valve stem 124; and a valve seat 127 which is fixed in the inside of the pressing body 129 so as to be closely attached to or detached from the valve body 126. An inlet 129b through which contents contained in the internal container 110 can be introduced is formed at the lower portion of the pressing body 129.

The dispenser receptacle according to the present invention as constructed above performs a pumping of contents through ascending and descending operations of the button 130. That is, when a user pushes the button 130 to move up at a state where he or she has held the external container 101, the internal container 110 moves upward with respect to the external container 101 by a force delivered through the movable sleeve 131. Accordingly, the valve body 126 is apart from the valve seat 127, and simultaneously the contents introduced into the pressing body 129 is pressurized and discharged through an exit 155 while passing through the communication path 125 and the communication path 122. In addition, if an upward force that has applied to the button 130 is stopped, the internal container 110 moves downwards to an original position by the spring 123, and an airless piston 111 moves upward as much as volume of the discharged contents. By doing such an operation repeatedly, a proper amount of the contents can be pumped and discharged externally.

As described above, in the case of the dispenser receptacle according to the present invention, the button 130 which makes the pumping unit 120 operate is provided at a side wall portion of the external container 101. Accordingly, a user makes the dispenser receptacle discharge contents more conveniently at a state where he or she has held the dispenser receptacle, to thereby use the discharged contents. In addition, since the button 130 has a structure that ascends and descends longitudinally along the side wall portion of the external container 101, a stroke of the button 130 becomes large to thus heighten an operational convenience. In addition, the height of the button 130 which is externally protruded is minimized, to thereby heighten a quality of the external appearance of a product, and respective products are made to closely contact each other, at the time of storing and displaying the products, to thereby enable a more efficient arrangement.

In addition, since the internal container 110 ascends and descends with respect to the external container 101, and the airless piston 111 is provided at the lower portion of the internal container 110, the structure of the pumping unit 120 is simplified as described above. As a result, an operational reliability and durability of a product can be enhanced. Even if contents contained in the dispenser receptacle is discharged, the external form of the dispenser receptacle is kept as it is, and contents are almost completely discharged so that there are little contents that remain in the inside of the dispenser receptacle after use.

### MODE FOR THE INVENTION

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention provides a dispenser receptacle or vessel which has a structure that a button is provided at a position near user's fingers when a user catches the dispenser receptacle, as well as an operational structure of performing a pumping by making the button move longitudinally.

1. A dispenser receptacle comprising:
an external container having an internal accommodation space whose upper portion is opened;
an internal container which is inserted into the inside of the external container so as to move longitudinally, and in the inside of which contents are accommodated;
a button which is combined so as to move longitudinally along the side wall portion of the external container;
a connection unit which connects the button and the internal container so that both sides of which move in integral form; and
a pumping unit which is combined with an exit portion of the internal container and pumps contents according to ascending and descending of the internal container to then discharge the pumped contents externally.

2. The dispenser receptacle according to claim 1, wherein the connection unit comprises a movable sleeve which is combined with the circumferential portion of the internal container, so as to move along the inner wall surface of the external container, in which the button is combined on the outer circumferential surface of the movable sleeve.

3. The dispenser receptacle according to claim 1, wherein an airless piston which moves up according to discharge of contents is provided at the lower-inner part of the internal container, and an inner cap having an exit is combined with the upper portion of the internal container, and wherein the pumping portion comprises:
a support tubular body having a communication path which is fixed to the inner cap and communicates with the exit;
a cover which is combined with the upper portion of the internal container and which is installed to receive an elastic force to the lower side of the support tubular body by a spring;
a pressing body which is combined with the inner side of the cover and has a pressure chamber which communicates with the inside of the internal container through an inlet;
a valve stem which is inserted into and combined with the support tubular body, in which a communication path which connects the pressure chamber of the pressing body and the communication path of the support tubular body is formed and a valve body is provided at the lower portion of the valve stem; and
a valve seat which is fixed in the inside of the pressing body so as to be closely attached to or detached from the valve body.

4. The dispenser receptacle according to claim 2, wherein an airless piston which moves up according to discharge of contents is provided at the lower-inner part of the internal container, and an inner cap having an exit is combined with the upper portion of the internal container, and wherein the pumping portion comprises:
a support tubular body having a communication path which is fixed to the inner cap and communicates with the exit;
a cover which is combined with the upper portion of the internal container and which is installed to receive an elastic force to the lower side of the support tubular body by a spring;
a pressing body which is combined with the inner side of the cover and has a pressure chamber which communicates with the inside of the internal container through an inlet;
a valve stem which is inserted into and combined with the support tubular body, in which a communication path which connects the pressure chamber of the pressing body and the communication path of the support tubular body is formed and a valve body is provided at the lower portion of the valve stem; and
a valve seat which is fixed in the inside of the pressing body so as to be closely attached to or detached from the valve body.
